(19) United States
(12) Patent Application Publication
(10) Pub. No.: US 2005/0156912 A1
(43) Pub. Date: Jul. 21, 2005

(54) Tethered stylyus for use with a capacitance-sensitive touchpad

(76) Inventors: Brian Taylor, Sandy, UT (US); Daniel Joseph Lee, Salt Lake City, UT (US); Paul Glad, Taylorsville, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/940,602

(22) Filed: Sep. 13, 2004

Related U.S. Application Data
(60) Provisional application No. 60/502,735, filed on Sep. 12, 2003.

(51) Int. Cl. G09G 5/00

(52) U.S. Cl. 345/179

(57) ABSTRACT

A tethered pen is coupled to an unused sense line input of touchpad sensor circuitry of a capacitance-sensitive touchpad, wherein the capacitance-sensitive touchpad is operable in a normal manner for detecting touch or proximity of a finger or other conductive pointing object to a touchpad surface by receiving input at a first sense input from a first sense line embedded within the touchpad, and wherein a second sense input is coupled to a tethered pen via a second sense line, wherein the second sense line enables the touchpad sensor circuitry to detect the touch of the pen on or in proximity to electrodes within the touchpad.

### BACKGROUND OF THE INVENTION

1. Field of the Invention

This invention relates generally to input devices for electronic information appliances. More specifically, the present invention provides a stylus that is tethered to an input of a capacitance-sensitive touchpad, wherein the capacitance-sensitive touchpad is operable to provide touchpad features such as cursor control for electronic information appliances such as computers, personal digital assistants (PDAs), credit card swipe devices, digital cameras, or mobile telephones, and wherein the tethered stylus provides a simultaneous input option for a user of the touchpad.

2. Description of Related Art

The state of the art of input devices utilizing a stylus is generally characterized by digitizing tablets or a touchpad. A digitizing tablet is generally a large surface that is used to input data with a stylus that is coupled to the tablet or touchpad. For example, a cable connects the stylus to the tablet, and movement of the stylus is detected or tracked as it moves across the surface of the tablet. The movement is typically portrayed as lines on a display.

The basis of operation for most stylus-based tablets is reliance upon electromagnetic sensors. A magnetic field is formed by electric current that is flowing in a loop. The stylus or pen has a coil that detects this magnetic field and sends it back to a converter that determines the X and Y position of the pen from this data. This type of pen generally requires a tether between the pen and a base device to transfer the data, or the use of an active pen that is battery powered and generates some type of signal that is detectable by the tablet or touchpad.

An example of such a pen is described in issued U.S. Pat. No. 5,914,708 and issued to Cirque Corporation. In this patent, the pen is not tethered and is passive, but includes a means for altering its own capacitive characteristics, and thus enabling variable input to a sensing device. The pen operates in conjunction with a touchpad because it is detected by the touchpad as any other capacitance-altering pointing object that is detectable thereby.

Disadvantageously, the pen is limited in its functionality. The pen can only send one signal to a sensing device. Thus, while the pen had the advantage of not requiring its own pen sensing hardware, it was of limited use and reliability. It is noted that the capacitance-sensitive touchpad used with the pen did not require any alternations, and could still be operated as a touchpad that is actuable by the use of a finger.

It would be an advantage over the prior art to provide a tethered pen that uses general purpose capacitance-sensitive touchpad technology to detect and track movement of the pen across a touch-sensitive surface thereof. It would be a further advantage over the prior art to enable the pen to have greater functionality and reliability than previous pen designs. It would be a further advantage if the tethered pen technology could be combined with the existing touchpad hardware, thereby decreasing manufacturing costs.

Before addressing specific hardware aspects of the present invention, it is helpful to understand the hardware and operation of a typical capacitance-sensitive touchpad that has been modified for use in the present invention. Specifically, a GLIDEPOINT™ touchpad from CIRQUE™ Corporation can be used with the present invention.

The CIRQUE™ Corporation touchpad that is used to describe implementation of the present invention is a mutual capacitance-sensing device. In this touchpad, a grid of row and column electrodes is used to define the touch-sensitive area of the touchpad. Typically, the touchpad is a rectangular grid of approximately 16 by 12 electrodes, or 8 by 6 electrodes when there are space constraints. Interlaced with these row and column electrodes is a single sense electrode. All position measurements are made through the sense electrode.

The Cirque Corporation touchpad measures an imbalance in electrical charge on the sense line. When no pointing object is on the touchpad, the touchpad circuitry is in a balanced state, and there is no charge imbalance on the sense line. When a pointing object creates imbalance because of capacitive coupling, a change in capacitance occurs on the electrodes. What is measured is the change in capacitance, but not the absolute capacitance value on the electrodes. The touchpad determines the change in capacitance by measuring the amount of charge that must be injected onto the sense line to reestablish or regain balance of charge on the sense line.

The system above is utilized to determine the position of a finger on a touchpad as follows. This example uses row electrodes, and is repeated in the same manner for the column electrodes. The values obtained from the row and column electrode measurements determine an intersection which is the centroid of the pointing object on the touchpad.

In the first step, a first set of row electrodes are driven with a first signal, and a different but adjacent second set of row electrodes are driven with a second signal. The touchpad circuitry obtains a value from the sense line that indicates which row electrode is closest to the pointing object. However, the touchpad circuitry cannot yet determine on which side of the row electrode the pointing object is disposed, nor can the touchpad circuitry determine just how far the pointing object is located away from the electrode. Thus, the system shifts by one electrode the group of electrodes to be driven. In other words, the electrode on one side of the group is added, while the electrode on the opposite side of the group is no longer driven. The new group is then driven and a second measurement of the sense line is taken.

From these two measurements, it is possible to determine on which side of the electrode the pointing object is located, and how far away. Pointing object position determination is then performed by using an equation that compares the magnitude of the two signals measured.

The sensitivity or resolution of the Cirque Corporation touchpad is much higher than the 16 by 12 grid of row and column electrodes implies. The resolution is typically on the order of 960 counts per inch, or greater. The exact resolution is determined by the sensitivity of the components, the spacing between the electrodes on the same rows and columns, and other factors that are not material to the present invention.

Although the GLIDEPOINT™ touchpad described above uses a grid of X and Y electrodes and a separate and single sense electrode, the sense electrode can also be the X or Y electrodes by using multiplexing. Either design will enable the present invention to function.

An important aspect of the operation of the touchpad as described above is the understanding that the touchpad circuitry of the GLIDEPOINT™ touchpad has two sensor inputs, and only one is used for detection of a finger during typical operation of the GLIDEPPOINT™ touchpad. Accordingly, it would be an advantage over the state of the art to utilize the unused sensor input for operation of a pen, without modification to or interference with existing hardware used for detection of a finger.

### BRIEF SUMMARY OF THE INVENTION

It is an object of the present invention to provide a tethered pen that is operable with a capacitance-sensitive touchpad.

It is another object to provide a tethered pen that is coupled to existing touch-sensing hardware of the capacitance-sensitive touchpad to thereby eliminate the need for additional hardware.

It is another object to provide a tethered pen that is coupled to an unused sense line input in existing touchpad hardware.

In a preferred embodiment, the present invention is a tethered pen is coupled to an unused sense line input of touchpad sensor circuitry of a capacitance-sensitive touchpad, wherein the capacitance-sensitive touchpad is operable in a normal manner for detecting touch or proximity of a finger or other conductive pointing object to a touchpad surface by receiving input at a first sense input from a first sense line embedded within the touchpad, and wherein a second sense input is coupled to a tethered pen via a second sense line, wherein the second sense line enables the touchpad sensor circuitry to detect the touch of the pen on or in proximity to electrodes within the touchpad.

In a first aspect of the invention, a sense-plus input and a sense-minus input are provided by the capacitance-sensitive touchpad sensing circuitry.

In a second aspect of the invention, the tethered pen is coupled to either the sense-plus or the sense-minus input, whichever is not being used by the capacitance-sensitive touchpad in its normal mode of operation.

In a third aspect of the invention, the pen is used to detect electrode patterns, thereby causing a detectable imbalance in the capacitance-sensitive touchpad circuitry, which thereby enables determination of the location of the pen on or in proximity to the surface of the capacitance-sensitive touchpad.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the prior art that shows that there is an unused sense input for the touchpad sensor circuitry 18.

FIG. 2 is a block diagram that is made in accordance with the principles of the present invention.

FIG. 3 is a top view of a touchpad disposed on an LCD display.

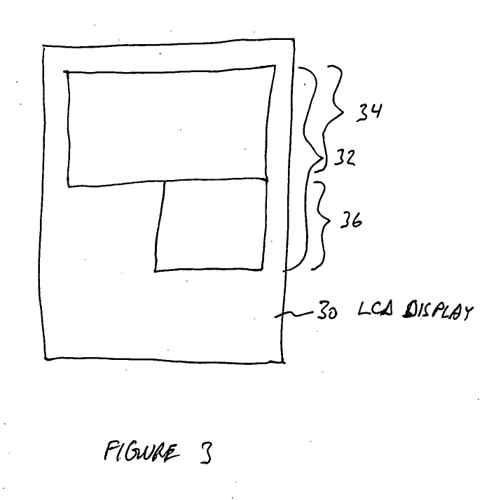

FIG. 4 is a partial cut-away perspective view of the pen 22.

FIG. 5 is a more complete partial cut-away perspective view of the pen 22.

FIG. 6 is a cut-away view of the pen 22 without any of the moving components disposed therein.

FIG. 7 is a close-up perspective view of the conductive ball 40 of the present invention.

FIG. 8 is a close-up perspective view of the conductive bar 46 of the present invention.

FIG. 9 is a close-up perspective view of the switch 48 of the present invention.

FIG. 10 is the cover 52 disposed over the conductive ball 40 on the writing end 50 of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is a tethered pen for use with a capacitance-sensitive touchpad to provide input to an electronic appliance. The electronic appliance may be, but should not be considered limited to, a personal computer, a personal digital assistance, a mobile telephone, a digital camera, a digital camcorder, a digital music player, a video player, or a notebook computer. The present invention includes the aspect of a touchpad that has been modified to include input from the tethered pen, as well as operate as a touchpad that detects the touch or proximity of a finger to the touchpad surface.

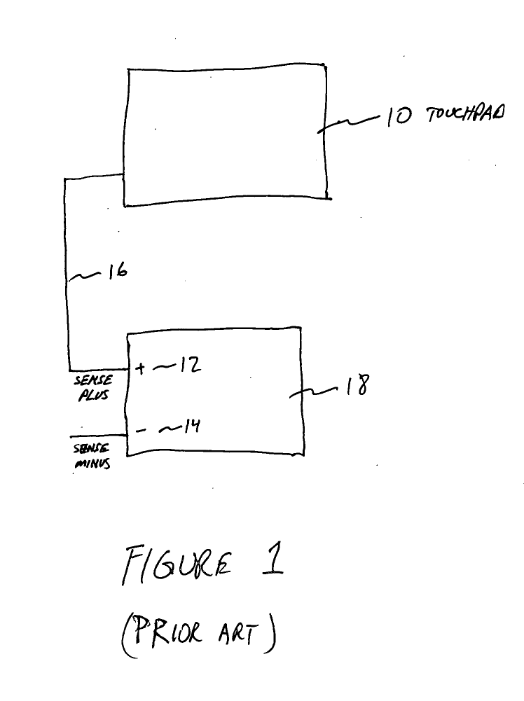

Beginning with the touchpad 10 in FIG. 1, it is noted that there are two possible sensor inputs from a CIRQUE™ CORPORATION capacitance sensitive touchpad to touchpad sensor circuitry 18. These two sensor inputs are sense-plus 12 (from sense line A 16) and sense-minus 14 (from sense line B). Typically, only one sense line 16 is used when operating in a typical configuration wherein the touchpad 10 is sensitive to the capacitive coupling of a finger or other conductive object to electrodes disposed under the touchpad 10.

In normal operation of the touchpad 10 of the present invention, the proximity of a finger to a touchpad surface, or actual contact with the touchpad surface, causes a decrease in a signal on sense line A that is being used for input to the touchpad sensor circuitry 18. Touchpad sensor circuitry 18 and associated algorithms are then used to localize and more accurately determine a precise location of the finger on or adjacent to the touchpad surface. This information is used in ways that are familiar to those skilled in the art, such as cursor control, etc.

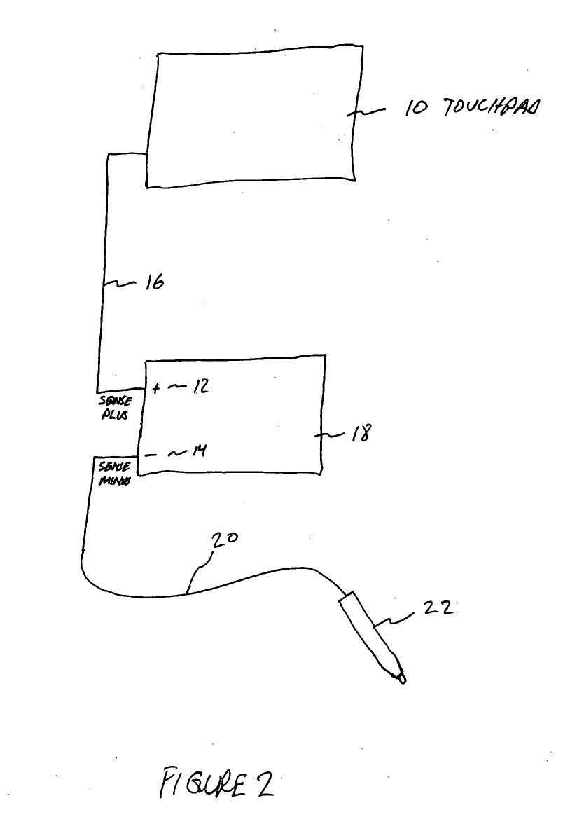

As show in FIG. 2 in the present invention, the unused sense minus input 14 is coupled via an electrical connection or tether 20 to a pen 22 of the present invention. Because the pen 22 is coupled to sense-minus input 14 via the tether 20 or sense line B, the pen will therefore generate a signal via sense line B that is opposite in polarity relative to a signal on sense line A 16 that will be generated by the touch of a finger.

It should also be remembered that there is an important difference in the location of the sense line providing data to touchpad circuitry when the finger is being detected and when the pen 22 is being detected. When the finger is being detected, the sense line is disposed in its typical location within the grid of electrodes of the touchpad 10. In contrast, the pen 22 is directly coupled to the sense line 20 that is not disposed within the touchpad electrodes. Rather, the sense line 20 for the pen 22 extends from the pen 20 to the sense-minus input 14. The sense line 20 in the pen 22 is coupled to a conductive detection end of the pen. The sense line 20 in the pen 20 detects the grid of X and Y electrodes in the touchpad 10, thereby causing an imbalance because there is an increase in signal on the sense line 20.

Thus, the present invention enables a dual use of the same touchpad 10. The touchpad sensor circuitry 18 can sense a finger on or near the touchpad 10 when input is derived from sense line A 16 that is embedded within the electrodes of the touchpad sensor grid. In contrast, the touchpad sensor circuitry 18 can sense the presence of the touchpad 10 when input is derived from the sense line 20 that is coupled to a conductive end of the pen 22 that is in contact with or adjacent to the touchpad 10.

Consider a touchpad 32 that is disposed over an LCD display 30. The touchpad 32 will be used for two distinct purposes. In a first active area 34, the touchpad 32 has electrodes that are spread further out over the LCD display 30. Thus, the touchpad 32 can function to detect the presence of a finger or other conductive pointing object within the first active area 34. For example, this are can be dedicated for displaying and buttons or switches that can be actuated by contact by a finger on the appropriate location. In a second active area 36 below the first active area 34, a smaller touchpad grid is provided. In this second active area 36, the electrodes are closer together, thus enabling the touchpad 32 to operate with a higher resolution. In this case, the object is a pen, and the second active area 36 is being used to detect a signature being made by the pen. The higher resolution is preferred in order to provide the writer clear and identifiable feedback in the form of the signature that is appearing on the LCD display 30n directly below the tip of the pen in the second active area 36. This system therefore provides improved visual feedback to a writer.

It is noted that the second active area 36 has the same number of electrodes as the first active area 34, but the smaller area results in smaller spacing between electrodes, and thereby enables the improved resolution of the touchpad 32 in the second active area 36.

It is an aspect of the invention that the first active area 34 could be made to be the same size as the second active area 36 to thereby enable the pen to have the resolution in both areas 34 and 36. Likewise, the smaller second active area 36 for the pen signature can also be used to detect the finger. The separate areas 34 and 36 were for convenience only, where the specific example was using the first active area 24 as a button surface, and the higher resolution devoted to recording and feedback of a written signature.

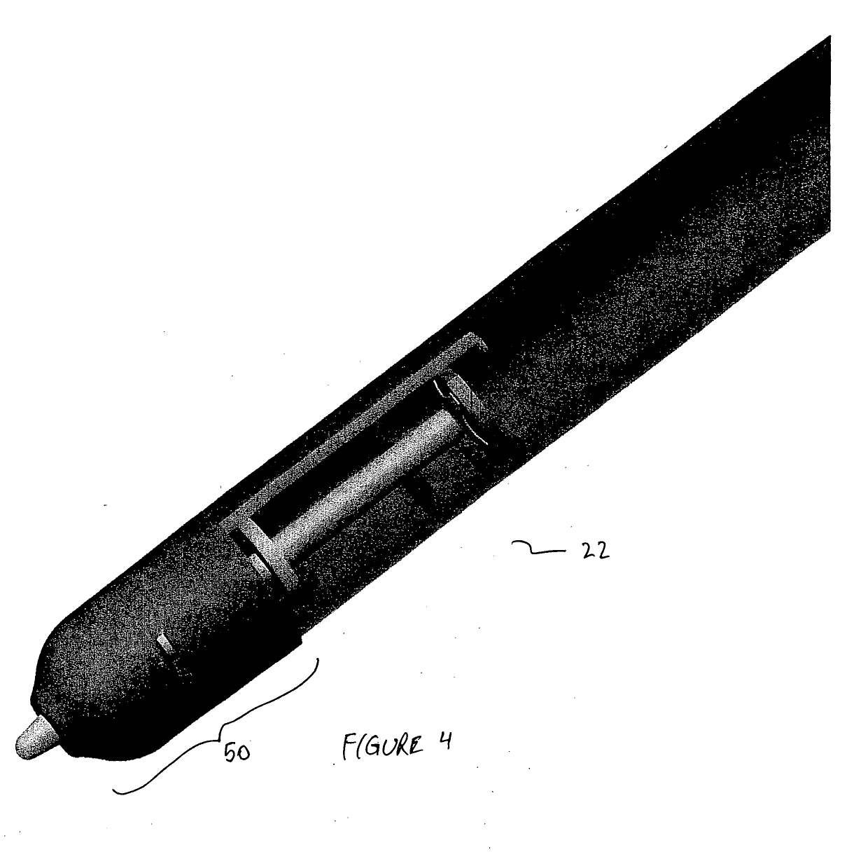

FIGS. 4 through 10 are also provided for a first embodiment for a tethered pen 22. FIG. 4 is a partially cut-away view of the interior of the pen 22.

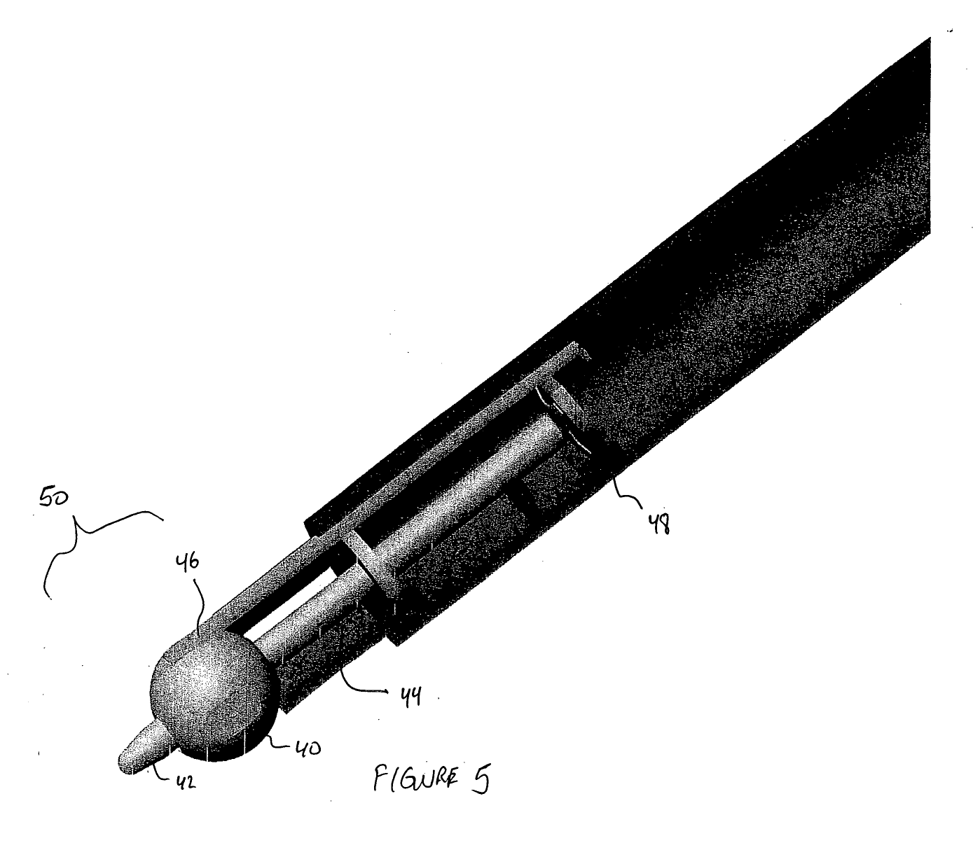

FIG. 5 is a cut-away view of the pen 22 that exposes a conductive ball 40, a tip 42, a rod 44, a conductive bar 46, and a switch 48.

The conductive ball 40 is shown at the writing end 50 of the pen 22. The conductive ball 40 is made relatively large so that it is easily detectable by the touchpad sensor circuitry 18. The sense line 20 from the sense-minus input 14 of the touchpad sensor circuitry 18 is attached to the conductive ball 40. The conductive ball 40 has also been made symmetrical in order to ensure that the pen 22 always appears the same to the touchpad sensor circuitry 18 no matter how the pen is being titled or held at any angle against the touchpad 10.

The pen 22 also includes the switch 48 that enables an inking and non-inking mode of the pen 22. When the pen 22 operates in a non-inking mode, the pen 22 detects the electrodes of the touchpad, and causes input to perform such functions as move a cursor or some other non-inking function. In this mode, the user is not pressing hard enough to actuate the switch 48. When the user presses harder on the tip 42 of the pen 22, the conductive ball 40 and attached conductive bar 46 slide backwards together in the body of the pen 22 until the switch 48 is pressed and actuated, thereby causing inking to be actuated on a display screen.

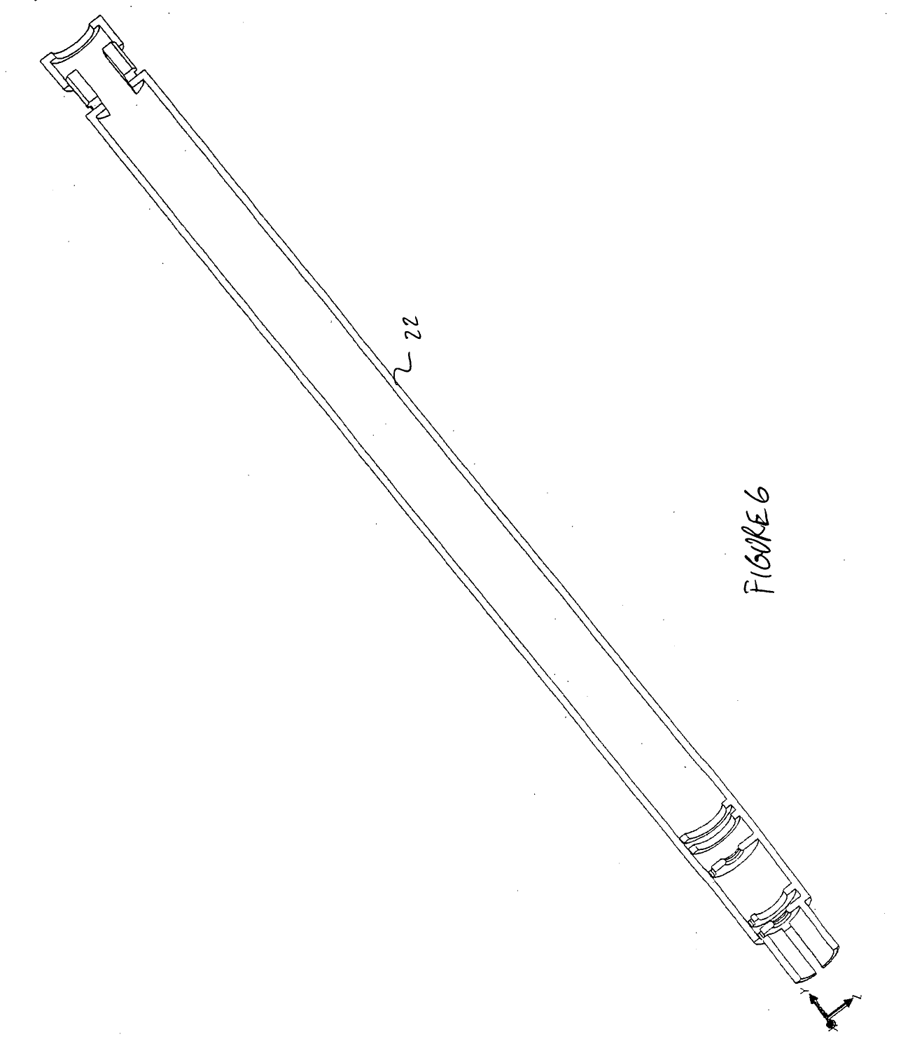

FIG. 6 is a cut-away view of the pen 22 without any of the moving components disposed therein.

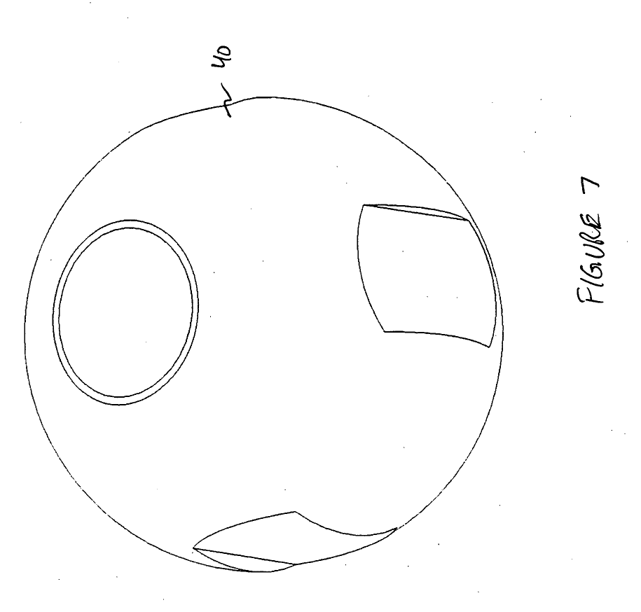

FIG. 7 is a close-up perspective view of the conductive ball 40 of the present invention.

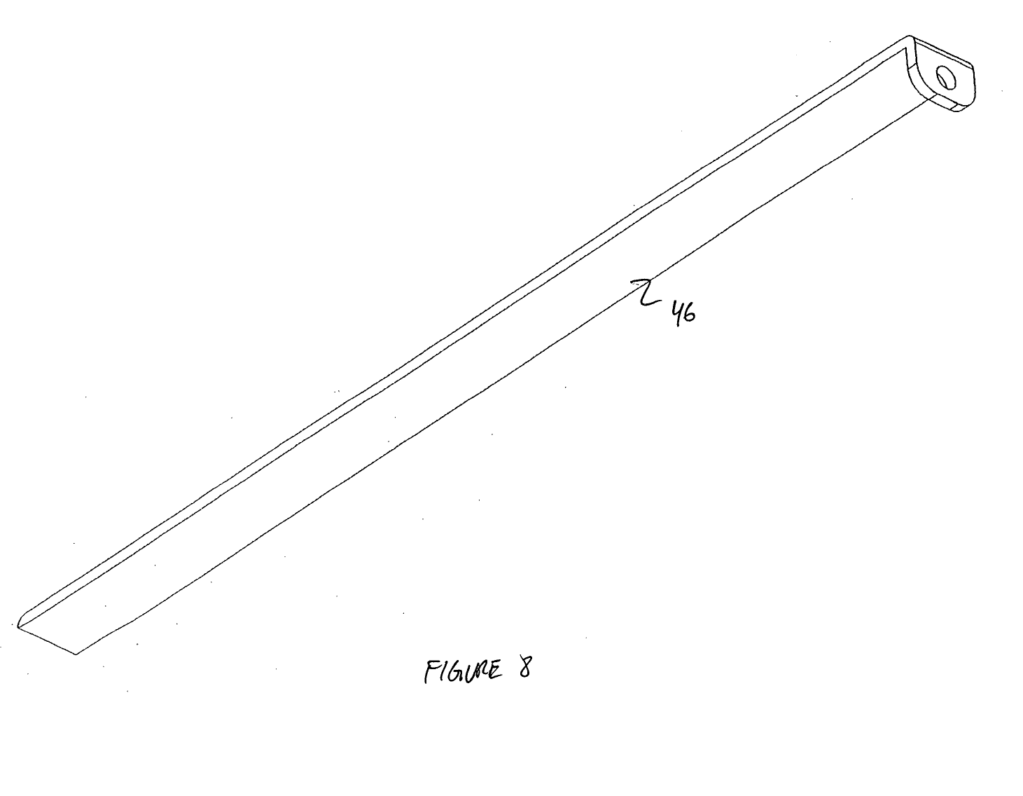

FIG. 8 is a close-up perspective view of the conductive bar 46 of the present invention.

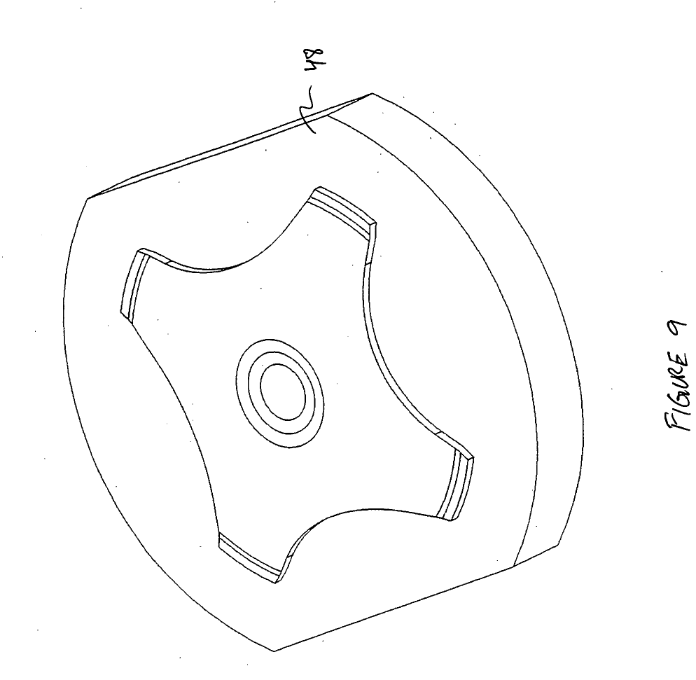

FIG. 9 is a close-up perspective view of the switch 48 of the present invention.

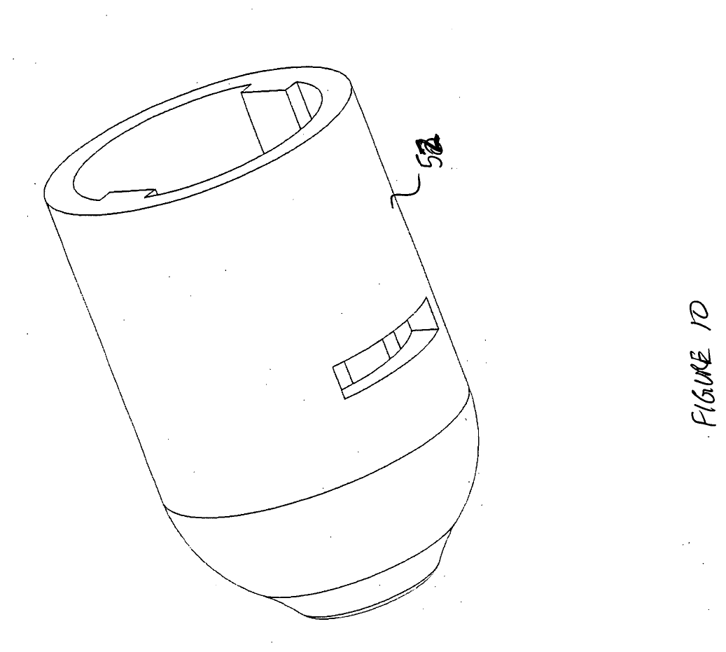

FIG. 10 is the cover 52 disposed over the conductive ball 40 on the writing end 50 of the present invention.

In an alternative embodiment, it is envisioned that a single sense input to the touchpad sensor circuitry 18 could be used to accept input from the touchpad 10 and from the pen 22. For example, a MUX can be used to change the input between the touchpad 10 and then pen 22.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

1. A passive pen for providing input to an electronic appliance, said pen comprised of:
a body for housing components therein, wherein the body has a writing end and an opposite end;
a conductive tip disposed within the body so as to be extend outside the body through an aperture in the writing end; and
a tether coupled to the conductive tip, wherein the tether is coupled to an electronic appliance to thereby provide data thereto.

2. The passive pen as defined in claim 1 wherein the passive pen is further comprised of:
a conductive ball disposed within the body of the pen and coupled to the conductive tip; and
a conductive strip coupled to the conductive ball, wherein the conductive strip is electrically coupled to the tether to thereby provide a pathway between the conductive tip and the tether.

3. The passive pen as defined in claim 2 wherein the passive pen is further comprised of:
a rod coupled to the conductive ball; and
a switch disposed within the body of the pen, wherein a force exerted on the conductive tip causes the conductive ball and the rod to move backwards with the body of the pen, wherein the rod actuates the switch.

4. The passive pen as defined in claim 3 wherein the passive pen is further comprised of touchpad sensor circuitry, wherein the touchpad sensor circuitry is coupled to the tether to thereby enable a signal from the pen to be transmitted to the touchpad sensor circuitry, and wherein the touchpad sensor circuitry determines the location of the conductive tip of the pen relative to a touchpad surface.

5. The passive pen as defined in claim 4 wherein the passive pen is further comprised of the touchpad sensor circuitry, wherein the touchpad sensor circuitry includes a sense-plus input and a sense-minus input.

6. The passive pen as defined in claim 5 wherein the passive pen is further comprised of a touchpad having a grid of X and Y electrodes, wherein the pen detects the X and Y electrodes when touching or in proximity of a surface of the touchpad.

7. The passive pen as defined in claim 6 wherein the touchpad sensor circuitry includes firmware that enables the touchpad sensor circuitry to determine the relative position of the pen and the surface of the touchpad.

8. The passive pen as defined in claim 7 wherein the touchpad is further comprised of a sense line disposed between the touchpad and the sense-plus input of the touchpad sensor circuitry.

9. The passive pen as defined in claim 1 wherein the electronic appliance is selected from the group of electronic appliances including a personal computer, a personal digital assistance, a mobile telephone, a digital camera, a digital camcorder, a digital music player, a video player, and a notebook computer.

10. A touchpad for providing input to an electronic appliance, wherein the touchpad is comprised of:
a grid of X and Y electrodes;
a sense electrode disposed adjacent to the grid of X and Y electrodes;
a passive pen having a tether for transmitting a signal from the passive pen; and
touchpad sensor circuitry for receiving input from the sense electrode for determining a location of a pointing object in contact with or in proximity of a surface of the touchpad, and for receiving input from the tether of the passive pen for determining a location of the touchpad relative to the pen.

11. The touchpad as defined in claim 10 wherein the touchpad sensor circuitry is further comprised of:
a sense-plus input for receiving input from the sense line; and
a sense-minus input for receiving input from the tether of the passive pen.

12. The touchpad as defined in claim 11 wherein the touchpad sensor circuitry includes firmware that enables the touchpad sensor circuitry to determine the relative position of the pen and the surface of the touchpad.

13. The touchpad as defined in claim 12 wherein the passive pen is further comprised of:
a body for housing components therein, wherein the body has a writing end and an opposite end; and
a conductive tip disposed within the body so as to be extended outside the body through an aperture in the writing end.

14. The touchpad as defined in claim 12 wherein the passive pen is further comprised of
a conductive ball disposed within the body of the pen and coupled to the conductive tip; and
a conductive strip coupled to the conductive ball, wherein the conductive strip is electrically coupled to the tether to thereby provide a pathway between the conductive tip and the tether.

15. The touchpad as defined in claim 14 wherein the passive pen is further comprised of:
a rod coupled to the conductive ball; and
a switch disposed within the body of the pen, wherein a force exerted on the conductive tip causes the conductive ball and the rod to move backwards with the body of the pen, wherein the rod actuates the switch.

16. A system for providing input to an electronic appliance, said system comprised of:
a touchpad;
a passive pen; and
touchpad sensor circuitry coupled to the touchpad and to the passive pen, wherein the touchpad sensor circuitry determines a location of a pointing object relative to the touchpad surface when operating in a touchpad mode, and wherein the touchpad sensor circuitry determines a location of the passive pen relative to the touchpad when operating in a pen mode.

17. The system as defined in claim 16 wherein the system is further comprised of the touchpad sensor circuitry having a sense-plus input for receiving data from the touchpad, and a sense-minus input for receiving data from the passive pen.

18. The system as defined in claim 17 wherein the passive pen is further comprised of:
a conductive ball disposed within the body of the pen and coupled to the conductive tip; and
a conductive strip coupled to the conductive ball, wherein the conductive strip is electrically coupled to the tether to thereby provide a pathway between the conductive tip and the tether.

19. The system as defined in claim 18 wherein the passive pen is further comprised of:
a rod coupled to the conductive ball; and
a switch disposed within the body of the pen, wherein a force exerted on the conductive tip causes the conductive ball and the rod to move backwards with the body of the pen, wherein the rod actuates the switch.

20. The system as defined in claim 19 wherein the system is further comprised of a tether disposed between the conductive strip and the sense-minus input of the touchpad sensor circuitry.

21. The system as defined in claim 17 wherein the system is further comprised of:
a grid of X and Y electrodes; and
a sense electrode disposed adjacent to the grid of X and Y electrodes, wherein the sense electrode is coupled to the sense-plus input of the touchpad sensor circuitry.

22. A method for providing input to an electronic appliance, said method comprising the steps of:
(1) providing a touchpad, a passive pen, and a touchpad sensor circuit coupled to the touchpad and to the passive pen;
(2) determining a location of a pointing object relative to the touchpad surface when operating in a touchpad mode; and
(3) determining a location of the passive pen relative to the touchpad when operating in a pen mode.

23. The method as defined in claim 22 wherein the method further comprises the step of providing the touchpad sensor circuitry with a sense-plus input for receiving data from the touchpad, and a sense-minus input for receiving data from the passive pen.

24. The method as defined in claim 23 wherein the method further comprises the steps of:
(1) providing a conductive ball disposed within the body of the pen and coupled to the conductive tip; and
(2) providing a conductive strip coupled to the conductive ball, wherein the conductive strip is electrically coupled to the tether to thereby provide a pathway between the conductive tip and the tether.

25. The method as defined in claim 24 wherein the method further comprises the steps of:
(1) providing a rod coupled to the conductive ball; and
(2) providing a switch disposed within the body of the pen, wherein a force exerted on the conductive tip causes the conductive ball and the rod to move backwards with the body of the pen, wherein the rod thereby actuates the switch.

26. The method as defined in claim 25 wherein the method further comprises the step of causing the passive pen to toggle between an inking mode and a non-inking mode whenever the switch is actuated.

27. The method as defined in claim 25 wherein the method further comprises the step of causing the passive pen to operate in an inking mode when the switch is actuated, and in a non-linking mode whenever the switch is not actuated.

28. The method as defined in claim 27 wherein the method further comprises the step of disposing a tether between the conductive strip and the sense-minus input of the touchpad sensor circuitry to thereby enable the passive pen to provide input to the touchpad.

29. The method as defined in claim 28 wherein the method further comprises the steps of:
(1) providing a grid of X and Y electrodes in the touchpad; and
(2) providing a sense electrode disposed adjacent to the grid of X and Y electrodes, wherein the sense electrode is coupled to the sense-plus input of the touchpad sensor circuitry.

30. A method for using a passive pen to provide input to an electronic appliance, said method comprising the steps of:
(1) providing a pen body for housing components therein, a conductive tip disposed within the pen body so as to be extend outside the pen body through an aperture in a writing end, and a tether coupled to the conductive tip;
(2) providing touchpad sensor circuitry, wherein the touchpad sensor circuitry is coupled to the tether; and
(3) transmitting a signal from the pen to the touchpad sensor circuitry, and wherein the touchpad sensor circuitry determines the location of the conductive tip of the pen relative to a touchpad surface.

31. The method as defined in claim 30 wherein the method further comprises the step of providing a conductive ball disposed within the pen body and coupled to the conductive tip to thereby enable the pen to be tilted at any desired angle without affecting the location determination of the touchpad sensor circuitry.

32. The method as defined in claim 31 wherein the method further comprises the steps of:
(1) providing a rod coupled to the conductive ball, and a switch disposed within the body of the pen, wherein a force exerted on the conductive tip causes the conductive ball to move backwards within the body of the pen, wherein the rod actuates the switch;
(2) operating in an inking mode when the switch is actuated; and
(3) operating in a non-inking mode when the switch is not actuated.

33. The method as defined in claim 32 wherein the method further comprises the step of providing a sense-plus input and a sense-minus input in the touchpad sensor circuitry to thereby enable the touchpad sensor circuitry to operate in a pen mode when receiving input from the pen.

34. The method as defined in claim 33 wherein the method further comprises the step of providing a touchpad having a grid of X and Y electrodes, wherein the pen detects the X and Y electrodes when touching or in proximity of a surface of the touchpad.

35. The method as defined in claim 34 wherein the method further comprises the step of providing a sense line between the touchpad and the sense-plus input of the touchpad sensor circuitry to thereby enable the touchpad sensor circuitry to operate in a touchpad mode.

36. The method as defined in claim 35 wherein the method further comprises the step of selecting the electronic appliance from the group of electronic appliances including a personal computer, a personal digital assistance, a mobile telephone, a digital camera, a digital camcorder, a digital music player, a video player, and a notebook computer.
